(19) United States
(12) Patent Application Publication
(10) Pub. No.: US 2023/0004499 A1
(43) Pub. Date: Jan. 5, 2023

(54) APPARATUS AND METHOD FOR EXTRACTING MEMORY MAP INFORMATION FROM FIRMWARE

(71) Applicant: ELECTRONICS AND TELECOMMUNICATIONS RESEARCH INSTITUTE, Daejeon (KR)

(72) Inventors: Yong-Je CHOI, Daejeon (KR); Dae-Won KIM, Daejeon (KR); Sang-Su LEE, Daejeon (KR); Byeong-Cheol CHOI, Daejeon (KR); Dong-Wook KANG, Daejeon (KR); Yang-Seo CHOI, Daejeon (KR)

(73) Assignee: ELECTRONICS AND TELECOMMUNICATIONS RESEARCH INSTITUTE, Daejeon (KR)

(21) Appl. No.: 17/737,174

(22) Filed: May 5, 2022

(30) Foreign Application Priority Data
Jun. 30, 2021 (KR) 10-2021-0086011

(51) Int. Cl. G06F 12/0873; G06F 12/0868

(52) U.S. Cl. CPC G06F 12/0873; G06F 12/0868

(57) ABSTRACT

Disclosed herein are an apparatus and method for extracting memory map information from firmware. The apparatus includes one or more processors and executable memory for storing at least one program executed by the one or more processors. The at least one program retrieves memory-related data from firmware, sets a data structure by analyzing binary code based on the memory-related data, and retrieves a memory map structure from the firmware using the data structure.

### CROSS REFERENCE TO RELATED APPLICATION

This application claims the benefit of Korean Patent Application No. 10-2021-0086011, filed Jun. 30, 2021, which is hereby incorporated by reference in its entirety into this application.

### BACKGROUND OF THE INVENTION

### 1. Technical Field

The present invention relates generally to firmware reverse-engineering analysis technology, and more particularly to technology for extracting memory map information from firmware.

### 2. Description of the Related Art

The use of embedded boards specialized for performing specific functions in a system requiring control is becoming increasingly popular. An embedded board includes firmware mounted therein in order to drive the board. Generally, such firmware may be vulnerable to security issues because it typically does not include a complex operating system (OS) therein. Further, because source code of a board is not provided in many cases, security vulnerabilities must be analyzed through binary code analysis. Memory-map-related information in firmware is essential data at the outset of such analysis, but this kind of information is not usually provided. In this case, extraction of memory-map-related information has to be performed through binary code analysis. Also, because most kinds of firmware are implemented in individual manners, when a target system is changed, an additional analysis process has to be performed therefor.

Meanwhile, Korean Patent No. 10-1995176, titled “Method and system for reverse engineering using big data based on program execution context”, discloses a method and system for reverse engineering using big data based on a program execution context, which store all program execution contexts and efficiently analyze the stored contexts.

### SUMMARY OF THE INVENTION

An object of the present invention is to enable memory-map-related information to be easily extracted from firmware.

Another object of the present invention is to provide analysis of security vulnerabilities in firmware.

In order to accomplish the above objects, an apparatus for extracting memory map information from firmware according to an embodiment of the present invention includes one or more processors and executable memory for storing at least one program executed by the one or more processors. The at least one program may retrieve memory-related data from firmware, set a data structure by analyzing binary code based on the memory-related data, and retrieve a memory map structure from the firmware using the data structure.

Here, the at least one program may output a name of data and an address offset thereof, which are retrieved using a predefined memory-related search term, as a memory-related data search result.

Here, the at least one program may further output a reference address value that refers to the address offset as the memory-related data search result.

Here, the at least one program may define a data structure to be used for retrieval of a memory map structure using a structure analyzed based on the memory-related data search result.

Here, the at least one program may retrieve the memory map structure using binary data between a start address and an end address based on which the data structure is defined.

Here, the at least one program may output addresses present around a name address in unstructured data retrieved based on the name of the data.

Also, in order to accomplish the above objects, a method for extracting memory map information from firmware, performed by an apparatus for extracting memory map information from firmware, according to an embodiment of the present invention includes retrieving memory-related data from firmware, defining a data structure by analyzing binary code based on the memory-related data, and retrieving a memory map structure from the firmware using the data structure.

Here, retrieving the memory-related data may comprise outputting a name of data and an address offset thereof, which are retrieved using a predefined memory-related search term, as a memory-related data search result.

Here, retrieving the memory-related data may comprise further outputting a reference address value that refers to the address offset as the memory-related data search result.

Here, defining the data structure may comprise defining a data structure to be used for retrieval of a memory map structure using a structure analyzed based on the memory-related data search result.

Here, retrieving the memory map structure may comprise retrieving the memory map structure using binary data between a start address and an end address based on which the data structure is defined.

Here, retrieving the memory-related data may comprise outputting addresses present around a name address in unstructured data retrieved based on the name of the data.

### BRIEF DESCRIPTION OF THE DRAWINGS

The above and other objects, features, and advantages of the present invention will be more clearly understood from the following detailed description taken in conjunction with the accompanying drawings, in which:

FIG. 1 and FIG. 2 are flowcharts illustrating a method for extracting memory map information from firmware according to an embodiment of the present invention;

FIG. 3 is a flowchart illustrating in detail an example of the step of retrieving memory-related data, illustrated in FIG. 2;

FIG. 4 is a view illustrating memory-map-related search terms predefined in a search term DB according to an embodiment of the present invention;

FIG. 5 is a view illustrating a result of retrieval of memory-related data according to an embodiment of the present invention;

FIG. 6 is a view illustrating an analyzed structure and a data structure according to an embodiment of the present invention;

FIG. 7 is a flowchart illustrating a process for retrieving unstructured memory map data according to an embodiment of the present invention; and

FIG. 8 is a view illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present invention will be described in detail with reference to the accompanying drawings.

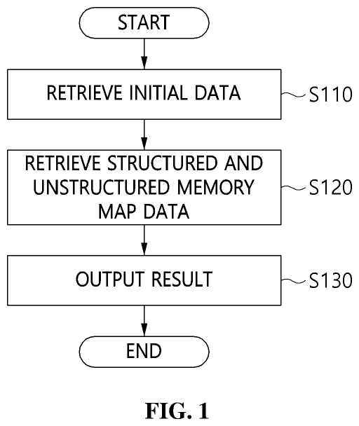

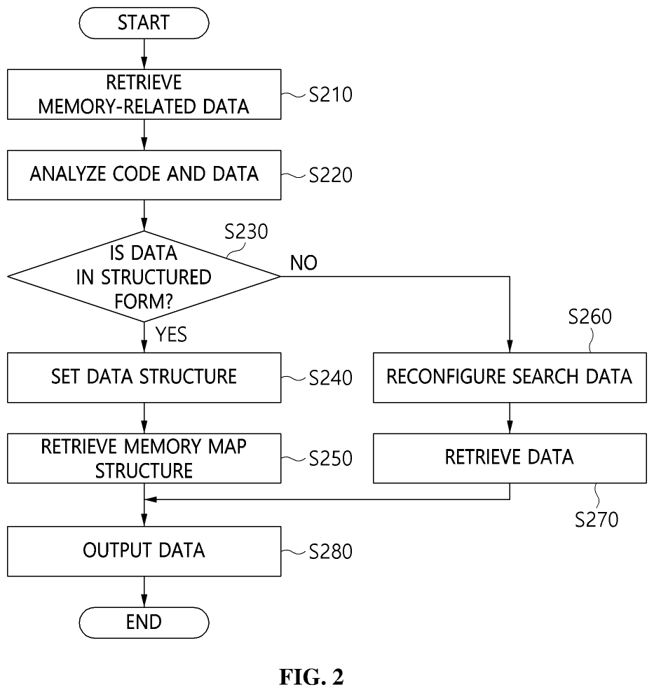

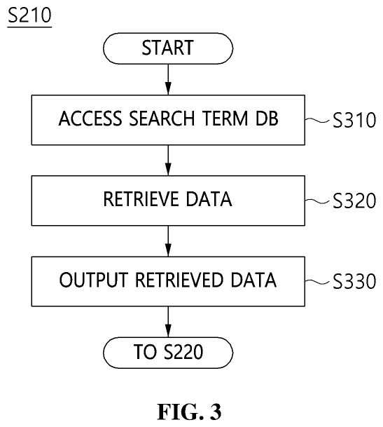

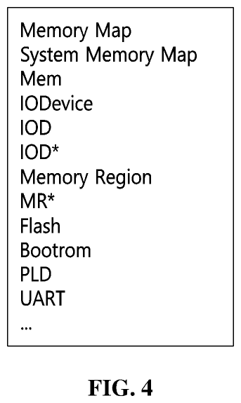

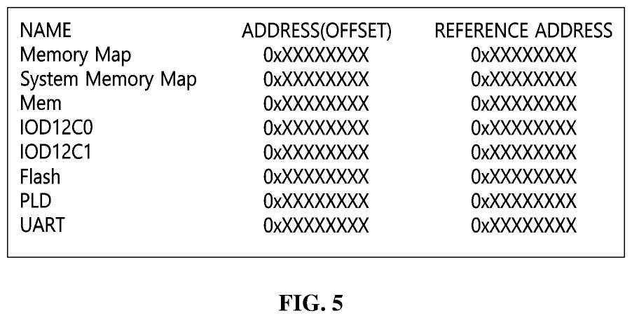

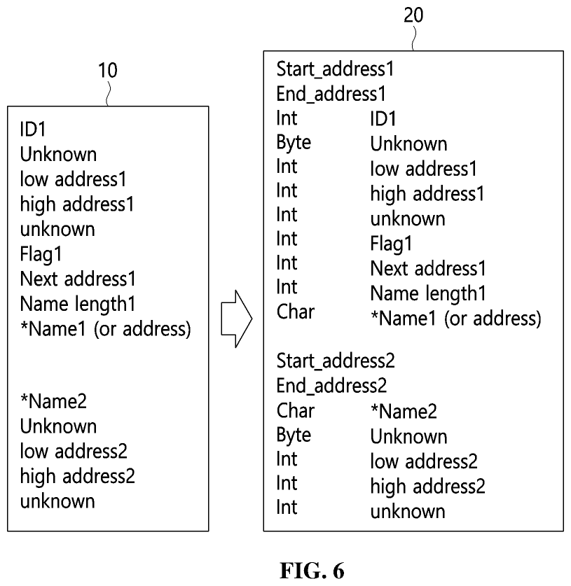

FIG. 1 and FIG. 2 are flowcharts illustrating a method for extracting memory map information from firmware according to an embodiment of the present invention. FIG. 3 is a flowchart illustrating in detail an example of the step of retrieving memory-related data, illustrated in FIG. 2. FIG. 4 is a view illustrating memory-map-related search terms predefined in a search term DB according to an embodiment of the present invention. FIG. 5 is a view illustrating a result of retrieval of memory-related data according to an embodiment of the present invention. FIG. 6 is a view illustrating an analyzed structure and a data structure according to an embodiment of the present invention.

Referring to FIG. 1, in the method for extracting memory map information from firmware according to an embodiment of the present invention, first, initial data may be retrieved at step S110.

Also, in the method for extracting memory map information from firmware according to an embodiment of the present invention, structured and unstructured memory map data may be retrieved at step S120.

Here, at step S120, memory map information having a structured form is extracted using the initial data retrieved at step S110, and information that does not correspond thereto may be extracted as unstructured memory map data.

Also, in the method for extracting memory map information from firmware according to an embodiment of the present invention, the result of retrieval of memory map data may be output at step S130.

FIG. 2 illustrates in detail the method for extracting memory map information from firmware according to an embodiment of the present invention, illustrated in FIG. 1.

In the method for extracting memory map information from firmware according to an embodiment of the present invention, memory-related data may be retrieved from firmware at step S210.

That is, at step S210, the name of data and the address offset thereof, which are retrieved using predefined memory-related search terms, may be output as a memory-related data search result.

Referring to FIG. 3, at step S210, first, a predefined search term database may be accessed at step S310.

Also, at step S210, the name of data and the address offset thereof may be retrieved using predefined memory-related search terms at step S320.

Here, at step S210, a reference address value that refers to the address offset may additionally be retrieved as the memory-related data search result.

Specific search terms may be used to retrieve all data including a given search term by attaching “*” thereto.

Also, at step S210, the retrieved data may be output at step S330.

That is, at step S330, the name, the address offset, and the reference address value referring to the address offset may be output as a search result.

Referring to FIG. 4, it can be seen that an example of memory-map-related search terms predefined in a search term database is illustrated.

Referring to FIG. 5, it can be seen that an example in which a retrieved name, a retrieved address offset, and a reference address value referring to the address offset are output as a search result is illustrated.

The search term database is a collection of memory-map-related search terms that are already well known, and a user may add search terms thereto. Here, relevant data that is newly found as a structure search result may also be added to the search term database.

Also, in the method for extracting memory map information from firmware according to an embodiment of the present invention, code and data may be analyzed at step S220.

That is, at step S220, binary code may be analyzed based on the retrieved memory-related data.

Here, at step S220, the form of a structure may be checked by analyzing the address value of the memory-related data using a binary analysis tool, such as Interactive DisAssembler (IDA).

In most firmware, memory map information, which is memory-related data having a structured form, is present in a data region, and memory-related data in an unstructured form may be present in a code region of firmware.

Also, in the method for extracting memory map information from firmware according to an embodiment of the present invention, whether the memory-related data is data in a structured form may be checked as the result of analysis thereof at step S230.

That is, at step S230, when the memory-related data is in a structured form, a data structure may be defined at step S240, whereas when the memory-related data is not in a structured form, search term data may be reconfigured at step S260.

That is, at step S240, a data structure may be defined based on the analysis result.

Here, at step S240, a data structure to be used to retrieve a memory map structure may be defined using a structure analyzed based on the memory-related data search result.

Referring to FIG. 6, it can be seen that an example of the analyzed structure 10 and a data structure 20 defined based thereon is illustrated.

The analyzed structure 10 may include an ID, a name (or name address), memory address region information (a low address, a high address), a flag, and the like. When analysis is performed, a number of pieces of unclear data (unknown) may be present, and when structures are discontinuous or when the name has a variable length, the address of a subsequent structure may be present.

The data structure 20 is a data structure to be used for retrieval, which is defined based on the analyzed structure 10.

In the data structure 20, a start address and an end address respectively indicate a start address and an end address to be retrieved, and structures defined for binary data between the start address and the end address are illustrated.

That is, at step S250, a memory map structure may be retrieved from the firmware using the data structure.

Here, at step S250, the memory map structure may be retrieved using the binary data between the start address and the end address based on which the data structure is defined.

Here, at step S250, a number of different forms of structures in a single chunk of binary data may be applied depending on the defined data structure, in which case retrieval may be performed at step S260 after a separate data structure is defined again.

Here, at step S250, the search term database used for the initial memory-related data search may be updated with a name included in the memory map structure search result.

At step S260, memory-related data may be retrieved again using the reconfigured search term data at step S270.

Also, in the method for extracting memory map information from firmware according to an embodiment of the present invention, the search result may be output at step S280.

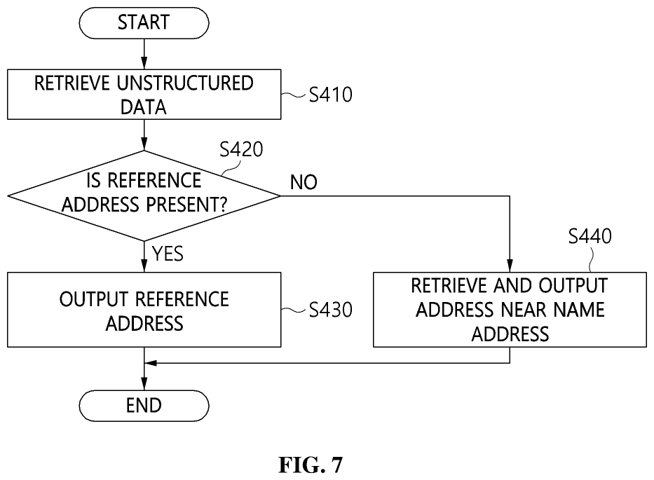

FIG. 7 is a flowchart illustrating a process for retrieving unstructured memory map data according to an embodiment of the present invention.

Referring to FIG. 7, it can be seen that a process for retrieving unstructured memory map data according to an embodiment of the present invention is illustrated in detail as an example of the unstructured data retrieval process at step S120 illustrated in FIG. 1.

First, at step S410, unstructured data may be retrieved from firmware.

That is, step S410 is performed based on a name included in the initial search result, in which case retrieval may be performed after removing a name that is present in the structured memory map data search result.

Here, at step S410, an address that refers to the name in the initial search result may not be retrieved, and this may be checked only through dynamic debugging.

That is, at step S420, when a reference address is present, the reference address may be output at step S430, whereas when a reference address is not present, addresses present around the name address may be retrieved and output.

These addresses may be the addresses of functions related to the retrieved data when a board actually operates.

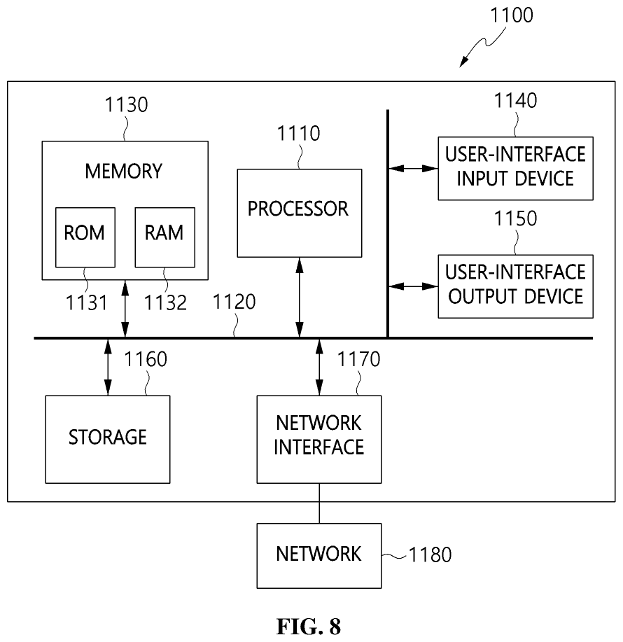

FIG. 8 is a view illustrating a computer system according to an embodiment of the present invention.

Referring to FIG. 8, the apparatus for extracting memory map information from firmware according to an embodiment of the present invention may be implemented in a computer system 1100 including a computer-readable recording medium. As illustrated in FIG. 8, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for extracting memory map information from firmware according to an embodiment of the present invention may include one or more processors 1110 and executable memory 1130 for storing at least one program executed by the one or more processors 1110. The at least one program may retrieve memory-related data from firmware, set a data structure by analyzing binary code based on the memory-related data, and retrieve a memory map structure from the firmware using the data structure.

Here, the at least one program may output the name of data and the address offset thereof, which are retrieved using predefined memory-related search terms, as a memory-related data search result.

Here, the at least one program may further output a reference address value that refers to the address offset as the memory-related data search result.

Here, the at least one program may define a data structure to be used for retrieval of a memory map structure using a structure analyzed based on the memory-related data search result.

Here, the at least one program may retrieve the memory map structure using binary data between a start address and an end address based on which the data structure is defined.

Here, the at least one program may output addresses present around a name address in unstructured data retrieved based on the name of the data.

The present invention may enable memory-map-related information to be easily extracted from firmware.

Also, the present invention may provide analysis of security vulnerabilities in firmware.

As described above, the apparatus and method for extracting memory map information from firmware according to the present invention are not limitedly applied to the configurations and operations of the above-described embodiments, but all or some of the embodiments may be selectively combined and configured, so that the embodiments may be modified in various ways.

What is claimed is:

1. An apparatus for extracting memory map information from firmware, comprising:
one or more processors; and
executable memory for storing at least one program executed by the one or more processors,
wherein the at least one program
retrieves memory-related data from firmware,
sets a data structure by analyzing binary code based on the memory-related data, and
retrieves a memory map structure from the firmware using the data structure.

2. The apparatus of claim 1, wherein:
the at least one program outputs a name of data and an address offset thereof, which are retrieved using a predefined memory-related search term, as a memory-related data search result.

3. The apparatus of claim 2, wherein:
the at least one program further outputs a reference address value that refers to the address offset as the memory-related data search result.

4. The apparatus of claim 3, wherein:
the at least one program defines a data structure to be used for retrieval of a memory map structure using a structure analyzed based on the memory-related data search result.

5. The apparatus of claim 4, wherein:
the at least one program retrieves the memory map structure using binary data between a start address and an end address based on which the data structure is defined.

6. The apparatus of claim 5, wherein:
the at least one program outputs addresses present around a name address in unstructured data retrieved based on the name of the data.

7. A method for extracting memory map information from firmware, performed by an apparatus for extracting memory map information from firmware, comprising:
retrieving memory-related data from firmware;
defining a data structure by analyzing binary code based on the memory-related data; and
retrieving a memory map structure from the firmware using the data structure.

8. The method of claim 7, wherein:
retrieving the memory-related data comprises outputting a name of data and an address offset thereof, which are retrieved using a predefined memory-related search term, as a memory-related data search result.

9. The method of claim 8, wherein:
retrieving the memory-related data comprises further outputting a reference address value that refers to the address offset as the memory-related data search result.

10. The method of claim 9, wherein:
defining the data structure comprises defining a data structure to be used for retrieval of a memory map structure using a structure analyzed based on the memory-related data search result.

11. The method of claim 10, wherein:
retrieving the memory map structure comprises retrieving the memory map structure using binary data between a start address and an end address based on which the data structure is defined.

12. The method of claim 9, wherein:
retrieving the memory-related data comprises outputting addresses present around a name address in unstructured data retrieved based on the name of the data.
